(19) United States
(12) Patent Application Publication
(10) Pub. No.: US 2026/0266712 A1
(43) Pub. Date: Sep. 10, 2026

(54) FUNCTIONAL LAYER INSPECTION METHOD AND FUNCTIONAL LAYER INSPECTION DEVICE

(71) Applicant: Samsung Display Co., Ltd., Yongin-Si (KR)

(72) Inventors: JONGYUN PARK, Yongin-si (KR); JAISUN KYOUNG, Yongin-si (KR); YOUNGGIL PARK, Yongin-si (KR)

(21) Appl. No.: 19/446,267

(22) Filed: Jan. 12, 2026

(30) Foreign Application Priority Data
Mar. 4, 2025 (KR) 10-2025-0027646
Apr. 11, 2025 (KR) 10-2025-0047372

(51) Int. Cl. G01N 21/21; G01B 11/06; G01N 21/84

(52) U.S. Cl. CPC G01N 21/211; G01B 11/0633; G01N 21/8422; G01N 2021/213; G01N 2021/8438

(57) ABSTRACT

Provided is a functional layer inspection method including measuring a polarization state of a sample on a base substrate through an inspection device, and calculating a physical property value of the sample through measurement data. The sample includes a first material and a second material. The calculating includes modeling an optical spectrum of the sample, grading the sample into a plurality of layers in a thickness direction of the sample, measuring inhomogeneity of peak changes in the optical spectrum of each of the plurality of layers, and calculating an analysis value to calculate content of the first material of the sample.

### CROSS-REFERENCE TO RELATED APPLICATIONS

This U.S. non-provisional patent application claims priority under 35 U.S.C. § 119 of Korean Patent Application Nos. 10-2025-0027646, filed on Mar. 4, 2025, and 10-2025-0047372, filed on Apr. 11, 2025, the entire contents of which are hereby incorporated by reference.

### BACKGROUND

The present disclosure herein relates to a functional layer inspection method and a functional layer inspection device, and more particularly, to a functional layer inspection method and a functional layer inspection device, which are capable of improving the consistency of a sample as an inspection target.

Spectroscopic ellipsometry technologies involve irradiating a sample with polarized light and measuring changes in a polarization state of reflected light. The polarization change (spectrum) with respect to wavelength varies depending on the properties and structure of the sample. Information on the properties and structure of the sample may be extracted and measured using the spectrum obtained through the spectroscopic ellipsometry technologies.

When a sample includes two or more materials each having different refractive indices in a specific ratio, and nanoparticles forming these two materials have an average size much smaller than the wavelength of light, this mixture may be approximated as a material with a single uniform refractive index, which is called effective medium approximation, and methods for calculating the effective medium approximation include Maxwell Garnett Equation or Bruggeman's Effective Medium Theory. The theory of effective medium approximation may be used to measure the properties of a sample including two or more materials.

However, when one of the two materials included in the sample is present in a trace amount, and only a portion of the sample, rather than the entire sample, is locally doped with this material, it is difficult to precisely measure the properties of the sample even with the theory of effective medium approximation, and significant scatter occurs between measurements, necessitating a new measurement method to overcome these issues.

### SUMMARY

The present disclosure provides a functional layer inspection method and a functional layer inspection device, which are capable of precisely calculating content of a material included in a sample including two or more mixed materials, even when the sample includes a trace amount of a specific material and a portion of the sample is locally doped with the specific material.

An embodiment of the inventive concept provides a functional layer inspection method including measuring a polarization state of a sample on a base substrate through an inspection device, and calculating a physical property value of the sample through measurement data. The sample includes a first material and a second material. The calculating includes modeling an optical spectrum of the sample, grading the sample into a plurality of layers in a thickness direction of the sample, measuring inhomogeneity of peak changes in the optical spectrum of each of the plurality of layers, and calculating an analysis value to calculate content of the first material of the sample.

In an embodiment, in the modeling, the optical spectrum of the sample may be modeled using effective medium approximation.

In an embodiment, in the grading, the sample may be divided into 3 to 5 layers in the thickness direction.

In an embodiment, the first material may be a p-type dopant, and the second material may be a hole injection material.

In an embodiment, the sample may include a first layer in which the first material and the second material are mixed, and a second layer disposed on the first layer and having a content of the first material lower than a content of the first material in the first layer.

In an embodiment, in the first layer, the content of the first material may be 1.5 wt % or less with respect to total materials of the first layer.

In an embodiment, the first layer may have a thickness smaller than a thickness of the second layer.

In an embodiment, the first layer may have a thickness of 80 Å to 120 Å, and the second layer may have a thickness of 220 Å to 280 Å.

In an embodiment, the sample may have a total thickness of 300 Å to 400 Å.

In an embodiment, the calculating the physical property value of the sample may further include calculating a total thickness of the sample prior to the grading.

In an embodiment, in the grading, the plurality of layers may form a single body.

In an embodiment, the base substrate may be a glass substrate.

In an embodiment, the inspection device may include an incident part configured to provide light to the sample, a receiving part configured to collect light reflected from the sample, and a computing module configured to detect, correct, and compute the light collected from the receiving part.

In an embodiment, in the grading, each of the plurality of layers may have a same thickness.

In an embodiment of the inventive concept, a functional layer inspection device includes an incident part configured to provide light to a sample, a receiving part configured to collect light reflected from the sample, and a computing module configured to detect, correct, and compute the light collected from the receiving part. The sample includes a first material and a second material. The computing module includes a first computing part configured to model an optical spectrum of the sample, a second computing part configured to grade the sample into a plurality of layers in a thickness direction of the sample, a third computing part configured to measure inhomogeneity of peak changes in the optical spectrum of each of the plurality of layers, and a fourth computing part configured to calculate an analysis value to calculate content of the first material of the sample.

In an embodiment, the first computing part may model the optical spectrum of the sample using effective medium approximation.

In an embodiment, the second computing part may divide the sample into 3 to 5 layers in the thickness direction.

In an embodiment, each of the plurality of layers may have a same thickness.

In an embodiment, the first material may be a p-type dopant, and the second material may be a hole injection material.

In an embodiment, the sample may include a first layer in which the first material and the second material are mixed, and a second layer disposed on the first layer and formed of the second material.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

FIG. 1 is a block diagram of an electronic device according to an embodiment.

FIG. 2 shows schematic views of electronic devices according to various embodiments of the inventive concept.

FIG. 3 is a perspective view of an electronic device according to an embodiment of the inventive concept.

FIG. 4 is an exploded perspective view of an electronic device according to an embodiment of the inventive concept.

FIG. 5 is a block diagram of an electronic device according to an embodiment of the inventive concept.

FIG. 6 is a block diagram of a display module according to an embodiment of the inventive concept.

FIG. 7 is a cross-sectional view of a display module according to an embodiment of the inventive concept.

FIG. 8 is a cross-sectional view of a portion of a display panel according to an embodiment of the inventive concept.

FIG. 9 is a cross-sectional view of a light emitting element according to an embodiment of the inventive concept.

FIG. 10 is a cross-sectional view of a portion of a light emitting element according to an embodiment of the inventive concept.

FIG. 11 is a block diagram briefly showing a functional layer inspection device according to an embodiment.

FIG. 12 is a flowchart of a functional layer inspection method according to an embodiment.

FIG. 13 is a cross-sectional view of a sample inspected through a functional layer inspection method according to an embodiment.

FIG. 14A is a graph showing a content measurement value of a target material according to a functional layer inspection method of a Comparative Example.

FIG. 14B is a graph showing a content measurement value of a target material according to a functional layer inspection method of an Example.

### DETAILED DESCRIPTION

The present disclosure may be modified in many alternate forms, and thus specific embodiments will be exemplified in the drawings and described in detail. It should be understood, however, that it is not intended to limit the present disclosure to the particular forms disclosed, but rather, is intended to cover all modifications, equivalents, and alternatives falling within the spirit and scope of the present disclosure.

In this specification, it will be understood that when an element (or a region, a layer, a portion, or the like) is referred to as being “on”, “connected to” or “coupled to” another element, it may be directly disposed on, connected to, or coupled to the other element, or other elements may be disposed therebetween.

In this application, being “disposed directly on” may mean that there is no additional layer, film, region, plate, or the like between a part and another part such as a layer, a film, a region, a plate, or the like. For example, being “disposed directly on” may indicate that two layers or two members are disposed without an additional member, such as an adhesive member, therebetween.

Like reference numerals or symbols refer to like elements throughout. In the drawings, the thickness, ratio, and size of the elements are exaggerated for effectively describing the technical contents. The term “and/or” includes any and all combinations of one or more of the associated listed elements.

It will be understood that, although the terms “first”, “second”, etc. may be used herein to describe various elements, the elements are not to be limited by these terms. These terms are only used to distinguish one element from another element. For instance, a first element could be termed a second element without departing from the scope of the inventive concept. Similarly, a second element could be termed a first element. The singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings. In this specification, “disposed on” may indicate being disposed not only on an upper portion but also on a lower portion of a member.

It will be further understood that the terms “comprises, includes, has” and/or “comprising, including, having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

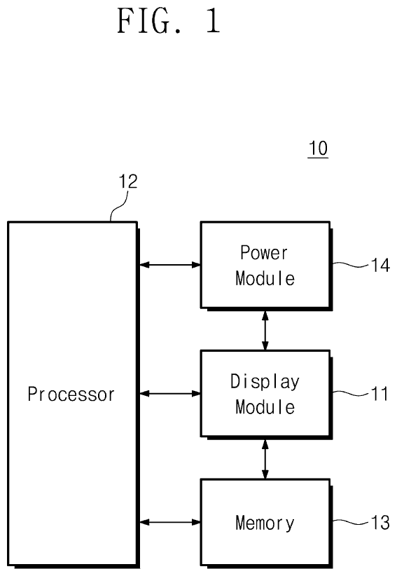

Hereinafter, embodiments of the inventive concept are described with reference to the drawings. First, with reference to FIGS. 1 to 10, a functional layer as a sample inspected through an inspection device and an inspection method according to an embodiment, and embodiments of a light emitting element and an electronic device including the same are described.

FIG. 1 is a block diagram of an electronic device 10 according to an embodiment.

Referring to FIG. 1, the electronic device 10 according to an embodiment may include a display module 11, a processor 12, a memory 13, and a power module 14.

The display module 11 may display images. The images may include still images as well as dynamic images. The processor 12 may include one or more processors and may include at least one of a central processing unit (CPU), an application processor (AP), a graphic processing unit (GPU), a communication processor (CP), an image signal processor (ISP), or a controller. The processor 12 may be configured to control the operation of the display module 11.

The memory 13 may store data information required for the operation of the processor 12 or the display module 11. When the processor 12 executes an application stored in the memory 13, image data signals and/or input control signals are transmitted to the display module 11, and the display module 11 may process the received signals and output image information through a display screen.

The power module 14 may include a power supply module such as a power adapter or a battery device, and a power conversion module that converts power supplied by the power supply module to generate power required for the operation of the electronic device 10.

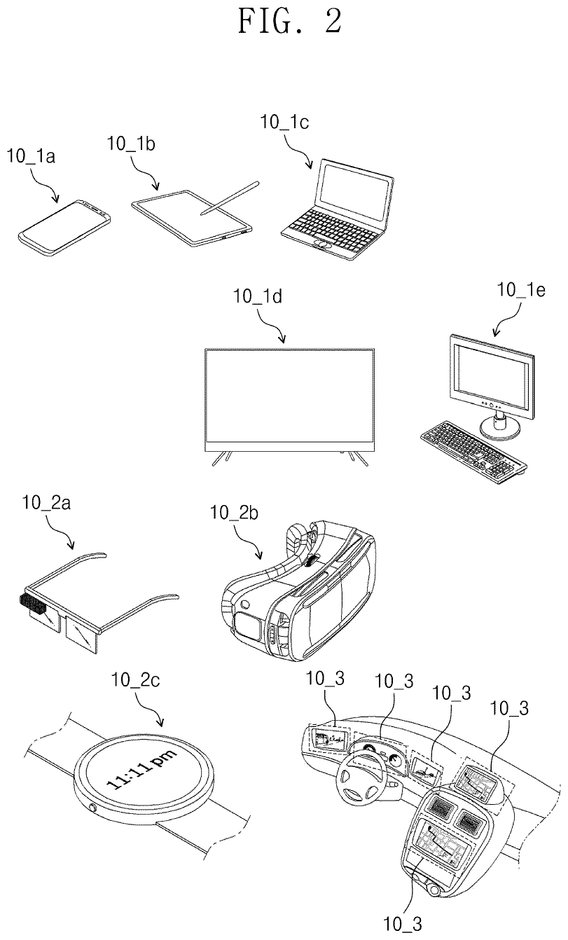

FIG. 2 shows schematic views of electronic devices according to various embodiments of the inventive concept.

Referring to FIG. 2, various electronic devices to which a display device according to embodiments is applied may include an electronic device for displaying images, such as a smart phone 10_1a, a tablet PC 10_1b, a laptop 10_1c, a TV 10_1d, and a desk monitor 10_1e, a wearable electronic device including a display module such as a smart glasses 10_2a, a head mounted display 10_2b, and a smart watch 10_2c, and a vehicle electronic device 10_3 including a display module such as a center information display (CID) and a room mirror display disposed on an instrument panel, a center fascia, or a dashboard of a vehicle.

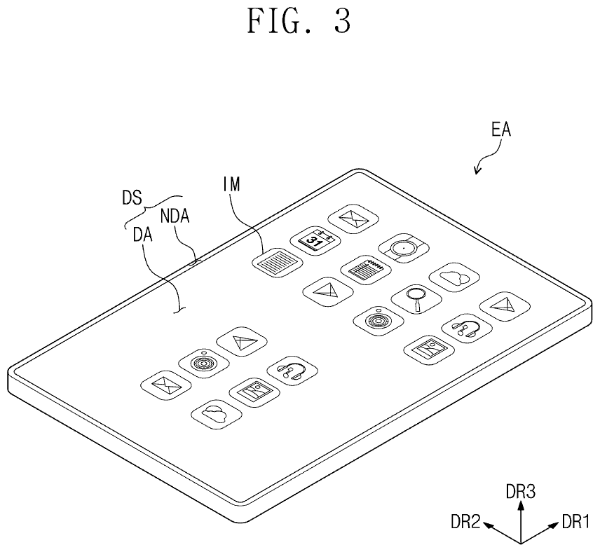

FIG. 3 is a perspective view of an electronic device EA according to an embodiment of the inventive concept.

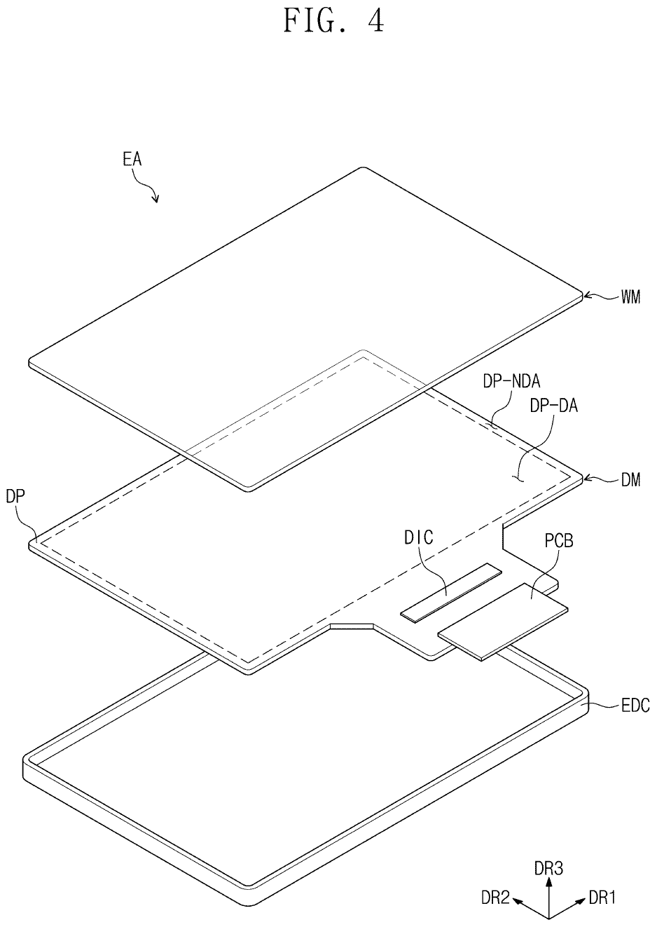

FIG. 4 is an exploded perspective view of an electronic device according to an embodiment of the inventive concept.

Referring to FIG. 3, the electronic device EA may be a device activated in response to an electric signal. The electronic device EA may display an image IM and detect an external input. The electronic device EA may include various embodiments. For example, the electronic device EA may include a tablet PC, a laptop computer, a computer, a smartphone, a television, etc. In the present embodiment, the electronic device EA is illustrated as a tablet PC. However, the embodiment of the inventive concept is not limited thereto, and the electronic device according to an embodiment may be a smartphone. In an embodiment, the electronic device according to an embodiment may be a large display device such as a laptop computer, a monitor, or a television. Although FIG. 3 illustrates a rigid electronic device EA, the embodiment of the inventive concept is not limited thereto, and the electronic device EA may be a flexible electronic device, at least a partial area of which is changed in shape according to a usage mode.

The electronic device EA may display the image IM in a third direction DR3 on a display surface DS parallel to each of a first direction DR1 and a second direction DR2. The display surface DS, on which the image IM is displayed, may correspond to a front surface of the electronic device EA and may correspond to a front surface of a window WM (see FIG. 4). Hereinafter, the display surface and front surface of the electronic device EA and the front surface of the window WM will be referred to by the same reference sign. The image IM may include still images as well as dynamic images. A plurality of icons is illustrated as an example of the image IM in FIG. 3.

In the present embodiment, front surfaces (or top surface) and rear surfaces (or bottom surfaces) of members are defined with respect to the direction in which the image IM is displayed. The front surfaces and the rear surfaces may oppose each other in the third direction DR3, and a normal direction of each of the front surfaces and the rear surfaces may be parallel with the third direction DR3. A distance between each of the front surfaces and each of the rear surfaces may correspond to a thickness of the electronic device EA in the third direction DR3. The directions indicated by the first to third directions DR1 to DR3 are relative concept and thus may be changed to other directions. Hereinafter, first to third directions which are indicated by the first to third directions DR1 to DR3 will be referred to by the same reference symbols. Furthermore, the term “in a plan view” used herein may represent a view from a plane defined by the first direction DR1 and the second direction DR2.

The electronic device EA according to an embodiment of the inventive concept may detect a user input applied externally. The user input includes various types of external inputs such as a part of a user's body, light, heat, or pressure. The user input may be provided in various forms, and the electronic device EA may detect the user input applied to a side or rear surface of the electronic device EA according to a structure of the electronic device EA, and is not limited to a certain embodiment.

FIG. 4 is an exploded perspective view of an electronic device according to an embodiment of the inventive concept.

As illustrated in FIG. 4, the electronic device EA includes the window WM, a display module DM, and an external case EDC. In the present embodiment, the window WM and the external case EDC are coupled to each other to form an exterior of the electronic device EA. In the present embodiment, the external case EDC, the display module DM, and the window WM may be sequentially stacked in the third direction DR3.

The window WM may include an optically clear material. The window WM may include an insulating panel. For example, the window WM may include glass, plastic, or a combination thereof.

The front surface of the window WM defines the front surface of the electronic device EA, as described above.

The window WM may include a bezel region and a transmissive region. The transmissive region may be an optically clear region. For example, the transmissive region may be a region having at least about 90% transmittance of visual light.

The bezel region may have a relatively low light transmittance compared to the transmissive region. The bezel region defines a shape of the transmissive region. The bezel region may be adjacent to and surround the transmissive region. The bezel region may have a certain color. The bezel region may overlap a non-display region DP-NDA of a display panel DP that will be described later. The bezel region may cover the non-display region DP-NDA of the display panel DP to prevent the non-display region DP-NDA from being externally viewed. This is merely an example, and the bezel region may not be provided to the window WM according to an embodiment of the inventive concept.

The display module DM may include at least the display panel DP. Although FIG. 4 only illustrates the display panel DP among stacked structures of the display module DM, the display module DM may substantially further include a plurality of elements disposed above and below the display panel DP. A stack structure of the display module DM will be described in detail later.

The display panel DP includes a display region DP-DA and the non-display region DP-NDA corresponding to the display region DA (see FIG. 3) and non-display region NDA (see FIG. 3) of the electronic device EA. In the present disclosure, the wording “region/portion corresponds to another region/portion” represents “overlapping each other”, but is not limited to cases in which the regions/portions have the same area size. The display module DM may include a driving chip DIC disposed on the non-display region DP-NDA. The display module DM may further include a printed circuit board PCB coupled to the non-display region DP-NDA. The printed circuit board PCB may be electrically connected to pads disposed in the non-display region DP-NDA of the display panel DP through an anisotropic conductive adhesive layer.

The driving chip DIC may include driving elements, for example, data driving circuit, for driving pixels of the display panel DP. Although FIG. 4 illustrates a structure in which the driving chip DIC is mounted on the display panel DP, the embodiment of the inventive concept is not limited thereto. For example, the driving chip DIC may also be mounted on the printed circuit board PCB.

The external case EDC may accommodate the display module DM and may be coupled to the window WM. The external case EDC may protect elements accommodated in the external case EDC, such as the display module DM.

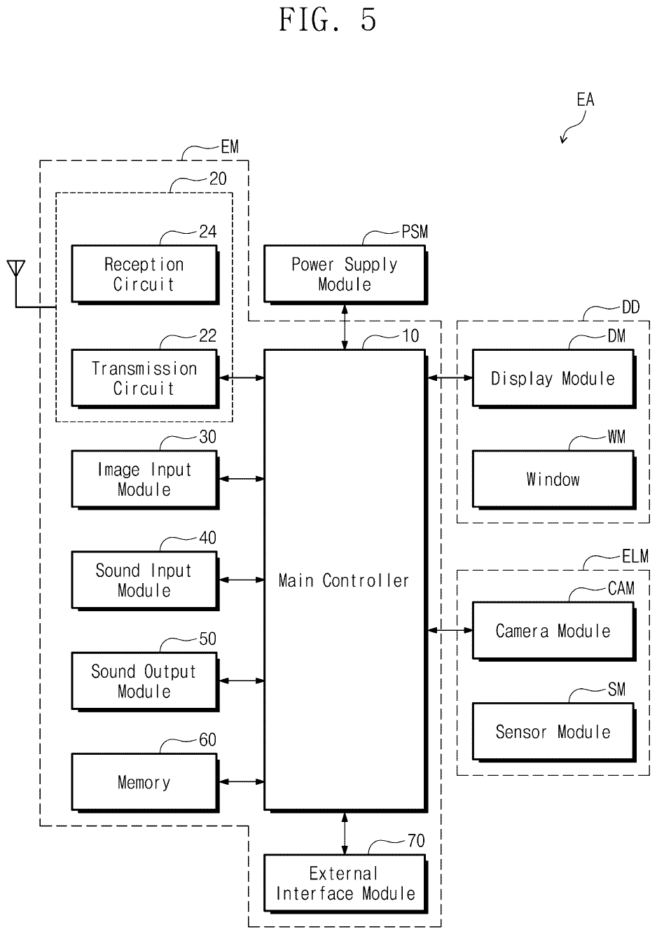

FIG. 5 is a block diagram of an electronic device EA according to an embodiment of the inventive concept. FIG. 5 schematically illustrates elements included in the electronic device EA described above through a block diagram.

A display device DD may generate an image and detect an external input. The display device DD may include the window WM and the display module DM.

A control module EM may include at least a main controller 10. The control module EM may include the main controller 10, a wireless communication module 20, an image input module 30, a sound input module 40, a sound output module 50, a memory 60, and an external interface module 70. The above modules may be mounted on a printed circuit board or may be electrically connected through a flexible circuit board. The control module EM may be electrically connected to a power supply module PSM.

The main controller 10 controls overall operation of the electronic device EA. For examples, the main controller 10 enables or disables the display device DD in accordance with a user input. The main controller 10 may control the image input module 30, the sound input module 40, the sound output module 50, etc. in accordance with a user input. The main controller 10 may include at least one microprocessor.

The wireless communication module 20 may transmit/receive a wireless signal to/from another terminal using a Bluetooth or WiFi line. The wireless communication module 20 may transmit/receive a voice signal using a general communication line. The wireless communication module 20 includes a transmission circuit 22, which modulates and transmits a signal to be transmitted, and a reception circuit 24, which demodulates a received signal.

The image input module 30 processes an image signal to convert the image signal into image data that is able to be displayed on the display device DD. The sound input module 40 receives an external sound signal through a microphone in a recording mode, a voice recognition mode, or the like, and converts the external sound signal into electric voice data. The sound output module 50 converts sound data received from the wireless communication module 20 or sound data stored in the memory 60 and outputs the converted sound data externally.

The external interface module 70 serves as an interface connected to an external charger, a wired/wireless data port, a card socket (e.g., a memory card, a SIM/UIM card), or the like.

An electronic module ELM may be an electronic component for outputting or receiving an optical signal. The electronic module ELM may be disposed below the display device DD. In the display panel DP of the display device DD, a signal transmissive region having higher light transmittance than another region is defined, and the electronic module ELM transmits or receives an optical signal through a partial region corresponding to the signal transmissive region. In the present embodiment, the electronic module ELM may include a camera module CAM. The camera module CAM may receive a natural light signal and capture an external image. The electronic module ELM may include a sensor module SM such as a proximity sensor, an ultraviolet light sensor, or the like. The sensor module SM may recognize a part of a user (e.g., fingerprint, iris, or face) or measure a distance between an object and a cell phone.

The power supply module PSM supplies power required for overall operation of the electronic device EA. The power supply module PSM may include a typical battery device.

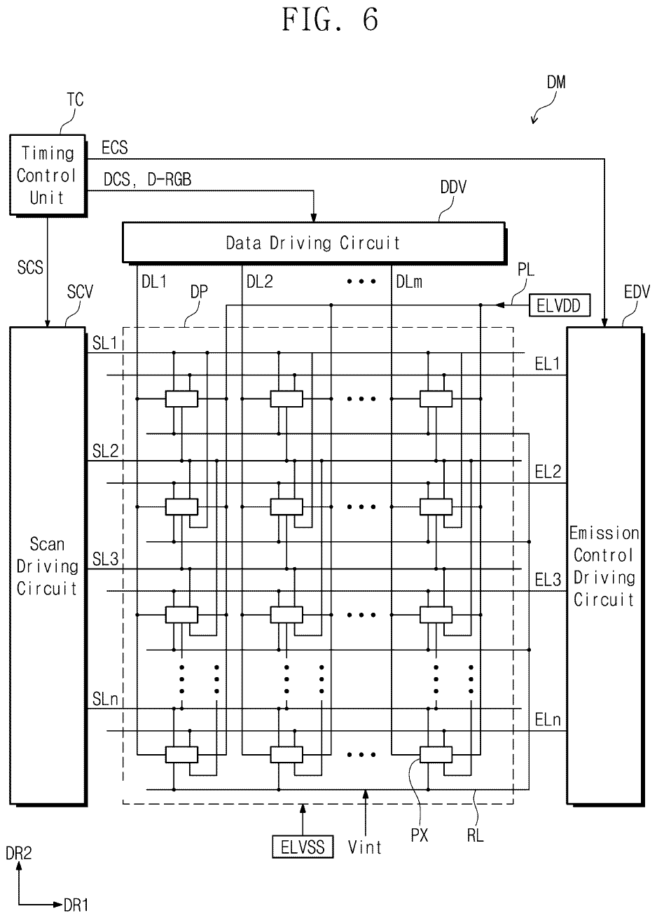

FIG. 6 is a block diagram of a display module DM according to an embodiment of the inventive concept. The display module DM according to an embodiment of the inventive concept may be a device including at least one semiconductor. The display module DM may include a timing control unit TC, a scan driving circuit SCV, a data driving circuit DDV, an emission control driving circuit EDV, and the display panel DP. The display panel DP display an image according to an electric signal.

In the present embodiment, the display panel DP is described as an organic light emitting display panel. This is merely an example, and the display panel DP according to the inventive concept may include various embodiments.

The timing control unit TC receives input image signals (not shown), and generates pieces of image data D-RGB by converting a data format of the input image signals so that the input image signals are compatible with a specification of an interface with the scan driving circuit SCV. The timing control unit TC outputs the pieces of image data D-RGB and various control signals DCS, SCS, and ECS.

The scan driving circuit SCV receives a scan control signal SCS from the timing control unit TC. The scan control signal SCS may include a vertical initiation signal for initiating operation of the scan driving circuit SCV and a clock signal for determining output time of signals.

The scan driving circuit SCV generates a plurality of scan signals, and sequentially outputs the plurality of scan signals to a plurality of scan lines SL1 to SLn.

The emission control driving circuit EDV receives an emission control signal ECS from the timing control unit TC. The emission control driving circuit EDV generates a plurality of emission control signals in response to the emission control signal ECS, and outputs the emission control signals to a plurality of emission lines EL1 to ELn.

Although the scan signals and the emission control signals are described as being separately output from the scan driving circuit SCV and the emission control driving circuit EDV, respectively, an embodiment of the inventive concept is not limited thereto, and the emission control driving circuit EDV may not be provided, and the scan signals and the emission control signals may be output from the scan driving circuit SCV.

The data driving circuit DDV receives the data control signal DCS and the pieces of image data D-RGB from the timing control unit TC. The data driving circuit DDV converts the pieces of image data D-RGB into data signals, and outputs the data signals to data lines DL1 to DLm (DL). The data signals are analog voltages corresponding to gradation values of the pieces of image data D-RGB.

The display panel DP includes the scan lines SL1 to SLn, the emission lines EL1 to ELn, the data lines DL1 to DLm, and pixels PX. The scan lines SL1 to SLn extend in the first direction DR1 and are arranged in the second direction DR2 intersecting the first direction DR1.

Each of the emission lines EL1 to ELn may be arranged in parallel with a corresponding scan line among the scan lines SL1 to SLn. The data lines DL1 to DLm insulatively intersect the scan lines SL1 to SLn.

Each of the pixels PX is connected to a corresponding scan line among the scan lines SL1 to SLn, a corresponding emission line among the emission lines EL1 to ELn, and a corresponding data line among the data lines DL1 to DLm.

Each of the pixels PX receives a first power supply voltage ELVDD and a second power supply voltage ELVSS lower than the first power supply voltage ELVDD. Each of the pixels PX is connected to a driving power supply line PL to which the first power supply voltage ELVDD is applied. Each of the pixels PX is connected to an initialization line RL which receives an initialization voltage Vint.

Each of the pixels PX may be electrically connected to three scan lines. As illustrated in FIG. 4, pixels of a second pixel row may be connected to the first to third scan line SL1 to SL3.

The display panel DP may further include a plurality of dummy scan lines. The display panel DP may further include a dummy scan line connected to the pixels PX of a first pixel row and a dummy scan line connected to the pixels PX of an n-th pixel row. Furthermore, pixels (hereinafter, pixels of a pixel column) connected to any one of the data lines DL1 to DLm may be connected to each other. Two adjacent pixels among pixels of a pixel column may be electrically connected. However, this is merely an example, and a connection relationship between the pixels PX according to an embodiment of the inventive concept may be variously designed, and is not limited to a certain embodiment.

Each of the pixels PX includes a light emitting element (not shown) and a pixel driving circuit (not shown) for controlling light emission of the light emitting element. The pixel driving circuit may include a thin film transistor and a capacitor. In the present embodiment, at least one of the scan driving circuit SCV, the emission control driving circuit EDV, or the data driving circuit DDV may include thin film transistors formed through the same process as the pixel driving circuit. For example, the scan driving circuit SCV, the emission control driving circuit EDV, and the data driving circuit DDV all may be mounted on the display panel DP. In an embodiment, two of the scan driving circuit SCV, the emission control driving circuit EDV, and the data driving circuit DDV may be mounted on the display panel DP, and the remaining one may be provided on the printed circuit board PCB (see FIG. 4) or may be provided to the separate driving chip DIC (see FIG. 4) independent of the display panel DP and connected to the display panel DP.

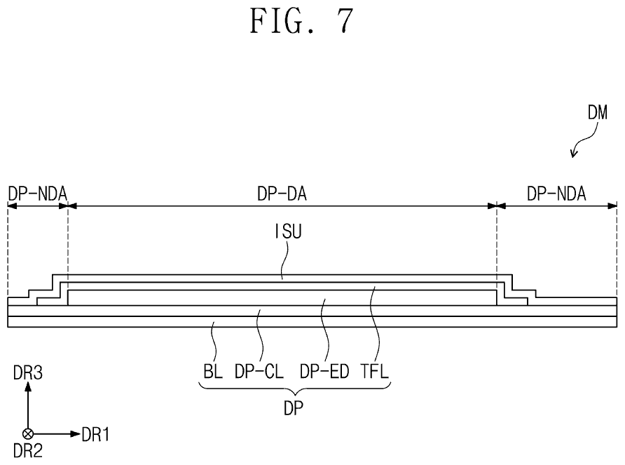

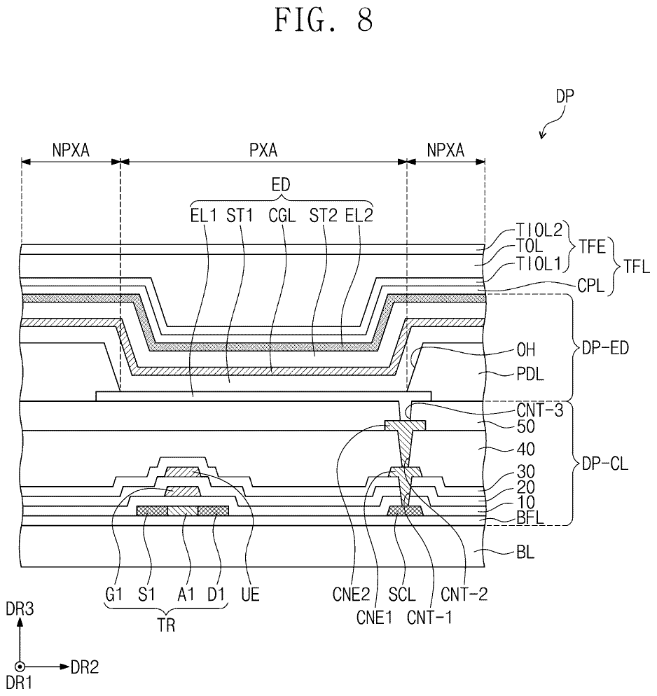

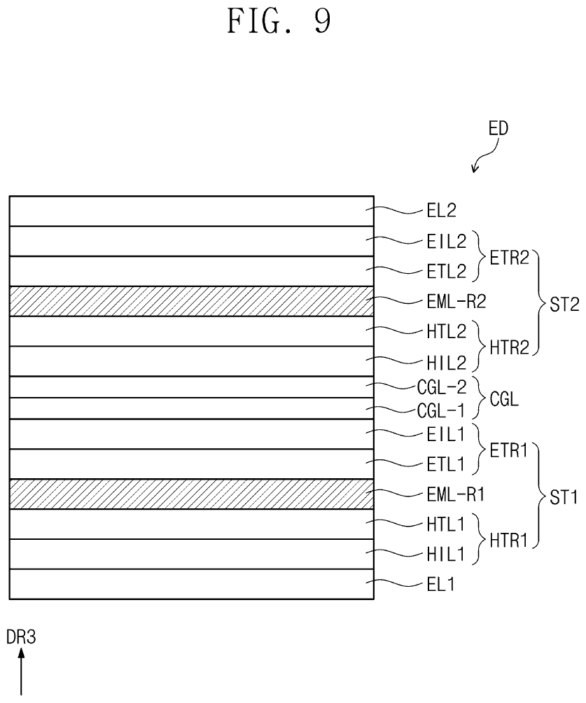

FIG. 7 is a cross-sectional view of a display module DM according to an embodiment of the inventive concept. FIG. 8 is a cross-sectional view of a portion of a display panel DP according to an embodiment of the inventive concept. FIG. 9 is a cross-sectional view of a light emitting element ED according to an embodiment of the inventive concept. FIG. 8 illustrates, as an example, a light emitting element ED and transistor TR included in one pixel of the display panel DP according to an embodiment.

Referring to FIG. 7, the display module DM may include the display panel DP and an input sensing unit ISU. The display panel DP may substantially generate the image IM (see FIG. 3). The image IM (see FIG. 3) generated by the display panel DP may be externally viewed by the user through the display region DA (see FIG. 3).

The display panel DP may be a light emitting display panel, but is not particularly limited. For example, the display panel DP may be an organic light emitting display panel or an inorganic light emitting display panel. The organic light emitting display panel may be a display panel in which an emission layer includes an organic light emitting material. The inorganic light emitting display panel may be a display panel in which an emission layer includes a quantum dot, quantum rod, or micro LED. Hereinafter, the display panel DP is described as an organic light emitting display panel.

The input sensing unit ISU may be disposed on the display panel DP. The input sensing unit ISU may detect an external input applied externally. The external input may include various types of inputs provided from the outside of the electronic device EA (see FIG. 1). The inputs provided from the outside may be provided in various forms. For example, the external input may include not only a contact by a part of body, such as a user's hand, but also an external input (e.g., hovering) that is in proximity to the electronic device EA or is provided within a certain distance from the electronic device EA. Furthermore, the external input may be in a form of force, pressure, light, etc., and is not limited to a certain embodiment.

The input sensing unit ISU may be formed on the display panel DP through a continuous process. In this case, the input sensing unit ISU may be directly disposed on the display panel DP. Herein, the wording “element B is directly disposed on element A” may indicate that a third component is not disposed between the element A and the element B. For example, an adhesive layer may not be disposed between the input sensing unit ISU and the display panel DP.

The display panel DP may include a base layer BL, a circuit layer DP-CL, a light emitting element layer DP-ED, and an upper insulating layer TFL disposed on the base layer BL.

The base layer BL may provide a base surface on which the circuit layer DP-CL, the light emitting element layer DP-ED, and the upper insulating layer TFL are disposed. The base layer BL may be a rigid substrate, or a flexible substrate that is bendable, foldable, rollable, or the like. The base layer BL may be a glass substrate, a metal substrate, or a polymer substrate. However, the embodiment of the inventive concept is not limited thereto, and the base layer BL may include an inorganic layer, an organic layer, or a composite material layer.

The base layer BL may have a multi-layer structure. For example, the base layer BL may include a first synthetic resin layer, an inorganic single-layer or multi-layer, and a second synthetic resin layer disposed on the inorganic single-layer or multi-layer. Each of the first and second synthetic resin layers may include a polyimide-based resin, but is not particularly limited.

The circuit layer DP-CL may be disposed on the base layer BL. The circuit layer DP-CL may include a plurality of insulating layers, a plurality of conductive layers, and a semiconductor layer. The plurality of conductive layers of the circuit layer DP-CL may constitute signal lines or a control circuit of a pixel.

The light emitting element layer DP-ED may be disposed on the circuit layer DP-CL. The light emitting element layer DP-ED may include light emitting elements. The light emitting element layer DP-ED may include, for example, organic light emitting elements. However, this is merely an example, and the light emitting element layer DP-ED according to an embodiment of the inventive concept may include inorganic light emitting elements, organic-inorganic light emitting elements, or a liquid crystal layer. The light emitting element layer DP-ED may further include a pixel defining structure. In the pixel defining structure, a pixel opening in which a light emitting element is disposed may be defined.

The upper insulating layer TFL may include a capping layer and an encapsulation layer that will be described later. The encapsulation layer may include an organic layer and a plurality of inorganic layers sealing the organic layer.

The upper insulating layer TFL may be disposed on the light emitting element layer DP-ED to protect the light emitting element layer DP-ED from moisture, oxygen, and foreign matter such as dust particles. The upper insulating layer TFL may seal the light emitting element layer DP-ED to block moisture and oxygen introducing to the light emitting element layer DP-ED. The upper insulating layer TFL may include at least one inorganic layer. The upper insulating layer TFL may include an organic layer and a plurality of inorganic layers sealing the organic layer. The upper insulating layer TFL may include a stack structure in which layers are stacked in order of inorganic layer/organic layer/inorganic layer.

The input sensing unit ISU is disposed on the upper insulating layer TFL. The input sensing unit ISU may be formed on the upper insulating layer TFL through a continuous process. The input sensing unit ISU may be directly disposed on the display panel DP. That is, an additional adhesive member may not be disposed between the input sensing unit ISU and the display panel DP. The input sensing unit ISU may be disposed in contact with an inorganic layer disposed in an uppermost portion of the upper insulating layer TFL.

Although not illustrated, the display module DM according to an embodiment of the inventive concept may further include a protective member disposed on a lower surface of the display panel DP and an anti-reflective member disposed on an upper surface of the input sensing unit ISU. The anti-reflective member may reduce reflectance of external light. The anti-reflective member may be directly disposed on the input sensing unit ISU through a continuous process.

The anti-reflective member may include a light shielding pattern overlapping a reflective structure disposed below the anti-reflective member. The anti-reflective member may further include a color filter. The color filter may include a first-color color filter, a second-color color filter, and a third-color color filter corresponding to a first-color pixel, a second-color pixel, and a third-color pixel and disposed between light shielding patterns.

As illustrated in FIG. 7, the display panel DP may be divided into the display region DP-DA and the non-display region DP-NDA in a plan view. The display region DP-DA of the display panel DP may be a region in which an image is displayed, and the non-display region DP-NDA may be a region in which a driving circuit, driving wiring, and the like are disposed. Light emitting elements of each of a plurality of pixels may be disposed in the display region DP-DA. The display region DP-DA may overlap at least a portion of the transmissive region of the window WM (see FIG. 4), and the non-display region DP-NDA may be covered with the bezel region of the window WM. The display region DP-DA and the non-display region DP-NDA of the display panel DP may respectively correspond to the display region DA and the non-display region NDA of the electronic device EA illustrated in FIG. 3.

Referring to FIGS. 7 and 8, in the display panel DP according to an embodiment, the circuit layer DP-CL, the light emitting element layer DP-ED, and the upper insulating layer TFL may be sequentially disposed on the base layer BL. The circuit layer DP-CL, the light emitting element layer DP-ED, and the upper insulating layer TFL will be described in detail with reference to FIG. 8.

The circuit layer DP-CL includes at least one insulating layer and a circuit element. The circuit element includes signal lines, pixel driving circuits, and the like. The circuit layer DP-CL may be formed through a process of forming an insulating layer, a semiconductor layer, and a conductive layer by coating, deposition, or the like and a process of patterning the insulating layer, the semiconductor layer, and the conductive layer by photolithography.

A buffer layer BFL may include at least one stacked inorganic layer. A semiconductor pattern is disposed on the buffer layer BFL. The buffer layer BFL improves a bonding force between the base layer BL and the semiconductor pattern.

The semiconductor pattern may include polysilicon. However, an embodiment of the inventive concept is not limited thereto, and, thus, the semiconductor pattern may include amorphous silicon or metal oxide. FIG. 8 only illustrates a partial semiconductor pattern, and another semiconductor pattern may be further disposed in another region of a pixel in a plan view. The semiconductor patterns may be disposed over pixels according to a particular rule.

The semiconductor pattern has different electrical properties according to with/without doping. The semiconductor pattern may include a first region A1 having low doping concentration and conductivity and second regions S1 and D1 having relatively high doping concentration and conductivity. One second region S1 may be disposed at one side of the first region A1, and the other second region D1 may be disposed at the other side of the first region A1. The second regions S1 and D1 may be doped with an N-type dopant or P-type dopant. A P-type transistor includes a doped region doped with a P-type dopant. The first region A1 may be a non-doped region or a region doped at a lower concentration than that of the second regions S1 and D1.

The second regions S1 and D1 may substantially function as an electrode or a signal line. One second region S1 may correspond to a source of the transistor TR, and other one second region D1 may correspond to a drain. FIG. 8 illustrates a portion of a connection signal line SCL formed from the semiconductor pattern. Although not illustrated, the connection signal line SCL may be connected to the drain of the transistor TR in a plan view.

A first insulating layer 10 may be disposed on the buffer layer BFL. The first insulating layer 10 commonly overlaps a plurality of pixels disposed in the display region DP-DA, and covers the semiconductor pattern. The first insulating layer 10 may be an inorganic layer and/or organic layer, and may have a single-layer or multi-layer structure. The first insulating layer 10 may include at least one of aluminum oxide, titanium oxide, silicon oxide, silicon oxynitride, zirconium oxide, or hafnium oxide. Not only the first insulating layer 10 but also the insulating layer of the circuit layer DP-CL described below may be an inorganic layer and/or organic layer, and may have a single-layer or multi-layer structure.

A gate G1 is disposed on the first insulating layer 10. The gate G1 may be a portion of a metal pattern. The gate G1 overlaps the first region A1. The gate G1 may function as a mask during a process of doping a semiconductor pattern.

A second insulating layer 20 may be disposed on the first insulating layer 10, and may cover the gate G1. The second insulating layer 20 commonly overlaps pixels. An upper electrode UE may be disposed on the second insulating layer 20. The upper electrode UE may overlap the gate G1. The upper electrode UE may include a metal multi-layer. In an embodiment of the inventive concept, the upper electrode UE may not be provided.

A third insulating layer 30 may be disposed on the second insulating layer 20, and may cover the upper electrode UE. A first connection electrode CNE1 may be disposed on the third insulating layer 30. The first connection electrode CNE1 may be connected to the connection signal line SCL through a contact hole CNT-1 penetrating the first to third insulating layers 10 to 30.

A fourth insulating layer 40 may be disposed on the third insulating layer 30, and a fifth insulating layer 50 may be disposed on the fourth insulating layer 40. The fourth insulating layer 40 may be an organic layer. A second connection electrode CNE2 may be disposed on the fourth insulating layer 40. The second connection electrode CNE2 may be connected to the first connection electrode CNE1 through a contact hole CNT-2 penetrating the fourth insulating layer 40.

The fifth insulating layer 50 may be disposed on the fourth insulating layer 40, and may be an organic layer.

The light emitting element ED may be disposed on the fifth insulating layer 50. The light emitting element ED may include a first electrode EL1, a first light emitting stack ST1, a charge generation layer CGL, and a second light emitting stack ST2, which are sequentially stacked.

The first electrode EL1 of the light emitting element ED may be disposed on the fifth insulating layer 50. The first electrode EL1 is connected to the second connection electrode CNE2 through a contact hole CNT-3 penetrating the fifth insulating layer 50. A pixel opening OH is defined in a pixel defining layer PDL so that the pixel defining layer PDL exposes at least a portion of the first electrode EL1. The pixel defining layer PDL may be an organic layer.

As illustrated in FIG. 8, the display region DP-DA may include a pixel region PXA and a non-pixel region NPXA adjacent thereto. The non-pixel region NPXA may surround the pixel region PXA. In the present embodiment, the pixel region PXA is defined to correspond to a partial region of the first electrode EL1 exposed by the pixel opening OH.

Referring to FIG. 9, the light emitting element ED included in a display panel according to an embodiment may include a plurality of light emitting stacks ST1 and ST2, and a charge generation layer CGL disposed between the plurality of light emitting stacks ST1 and ST2. The light emitting element ED according to an embodiment may include a first electrode EL1, the first light emitting stack ST1, the charge generation layer CGL, and the second light emitting stack ST2, which are sequentially stacked. Although FIG. 8 illustrates that the light emitting element ED includes two light emitting stacks ST1 and ST2, and one charge generation layer CGL disposed therebetween, the embodiment of the inventive concept is not limited thereto, and the light emitting element ED may include at least three light emitting stacks.

Referring to FIG. 9, each of the plurality of light emitting stacks ST1 and ST2 includes a plurality of functional layers. Each of the plurality of light emitting stacks ST1 and ST2 may include emission layers EML-R1 and EML-R2, hole transport regions HTR1 and HTR2 and electron transport regions ETR1 and ETR2 disposed with the emission layers EML-R1 and EML-R2 therebetween. For example, as illustrated in FIGS. 4 to 8, the first light emitting stack ST1 may include a first emission layer EML-R1, and the second light emitting stack ST2 may include a second emission layer EML-R2. That is, the light emitting element ED may be a light emitting element having a tandem structure including a plurality of light emitting stacks that include emission layers.

In the embodiment illustrated in FIG. 8, light emitted from each of the plurality of light emitting stacks ST1 and ST2 may have the same wavelength. For example, the light emitted from each of the plurality of light emitting stacks ST1 and ST2 may be blue light. However, the embodiment of the inventive concept is not limited thereto, and the plurality of light emitting stacks ST1 and ST2 may emit light of different wavelength regions. For example, at least one of the plurality of light emitting stacks ST1 and ST2 may emit blue light and other stacks may emit green light. The light emitting element ED including the plurality of light emitting stacks ST1 and ST2 that emit light of different wavelength regions may emit white light.

The charge generation layer CGL may be disposed between the first light emitting stack ST1 and the second light emitting stack ST2.

When being applied with voltage, the charge generation layer CGL may generate charges (electrons and holes) by forming complexes through oxidation-reduction reaction. Furthermore, the charge generation layer CGL may provide generated charges to each of the adjacent stacks ST1 and ST2. The charge generation layer CGL may double efficiency of current generated in respective adjacent stacks ST1 and ST2, and may function to adjust balance of charges between adjacent stacks ST1 and ST2.

The charge generation layer CGL may have a layer structure in which a lower charge generation layer CGL-1 and an upper charge generation layer CGL-2 are bonded to each other. The lower charge generation layer CGL-1 may be an n-type charge generation layer disposed adjacent to the first light emitting stack ST1 to provide electrons to the first light emitting stack ST1. The lower charge generation layer CGL-1 may be a layer in which a base material is doped with an n-dopant. The upper charge generation layer CGL-2 may be a p-type charge generation layer disposed adjacent to the second light emitting stack ST2 to provide holes to the second light emitting stack ST2. The upper charge generation layer CGL-2 may be a layer in which a base material is doped with a p-dopant.

The lower charge generation layer CGL-1 and the upper charge generation layer CGL-2 each may include an aryl amine-based organic compound, metal, metal oxide, carbide, fluoride, or a charge generating compound composed of a mixture thereof. For example, the aryl amine-based organic compound may include α-NPD, 2-TNATA, TDATA, MTDATA, sprio-TAD, or sprio-NPB. For example, the metal may include cesium (Cs), molybdenum (Mo), vanadium (V), titanium (Ti), tungsten (W), barium (Ba), or lithium (Li). The metal oxide, carbide, fluoride, or mixtures thereof may include, for example, Re₂O₇, MoO₃, V₂O₅, WO₃, TiO₂, Cs₂CO₃, BaF, LiF, or CsF, or mixtures thereof.

A buffer layer may be further disposed between the lower charge generation layer CGL-1 and the upper charge generation layer CGL-2.

In an embodiment, the light emitting element ED may emit light in a direction from the first electrode EL1 to a second electrode EL2. The light emitting element ED according to an embodiment is illustrated as having a structure in which the hole transport regions HTR1 and HTR2 are disposed below the emission layers EML-R1 and EML-R2 of respective stacks, with respect to a direction of light emission, and the electron transport regions ETR1 and ETR2 are disposed above the emission layers EML-R1 and EML-R2 of respective stacks. However, the embodiment of the inventive concept is not limited thereto, and the light emitting element ED may have an inverted element structure in which the electron transport regions ETR1 and ETR2 are disposed below the emission layers EML-R1 and EML-R2 of respective stacks, with respect to the direction of light emission, and the hole transport region HTR1 and HTR2 are disposed on the emission layers EML-R1 and EML-R2 of respective stacks.

In the light emitting element ED according to an embodiment, the first light emitting stack ST1 and the second light emitting stack ST2 respectively include the emission layers EML-R1 and EML-R2 that emit light of a particular wavelength. For example, the emission layers EML-R1 and EML-R2 may emit light of a first wavelength in the same range. The emission layers EML-R1 and EML-R2 each may include the same host material and dopant material.

In an embodiment, the light of the first wavelength may be light of a blue wavelength region. The light of the first wavelength may be light of a wavelength region of about 410 nm to about 480 nm. The emission layers EML-R1 and EML-R 2 each may include a host material and a blue light emitting dopant. A dopant included in the emission layers EML-R 1 and EML-R 2 may be a blue fluorescent dopant. In an embodiment, the light of the first wavelength may be light of a green wavelength region. The light of the first wavelength may be light of a wavelength region of about 500 nm to about 600 nm. The emission layers EML-R 1 and EML-R 2 each may include a host material and a green light emitting dopant. A dopant included in the emission layers EML-R1 and EML-R2 may be a green phosphorescent dopant. In an embodiment, the light of the first wavelength may be light of a red wavelength region. The light of the first wavelength may be light of a wavelength region of about 620 nm to about 700 nm. The emission layers EML-R1 and EML-R2 each may include a host material and a red light emitting dopant. A dopant included in each of the emission layers EML-R1 and EML-R2 may be a red phosphorescent dopant.

The first light emitting stack ST1 may further include the first hole transport region HTR1 for transporting holes generated from the first electrode EL1 to the first emission layer EML-R1 and the first electron transport region ETR1 for transporting electrons provided from the charge generation layer CGL to the first emission layer EML-R1.

The first hole transport region HTR1 may include a first hole injection layer HIL1 disposed on the first electrode EL1 and a first hole transport layer HTL1 disposed on the first hole injection layer HIL1. The first hole transport layer HTL1 may be in contact with a lower surface of the first emission layer EML-R1. The first hole injection layer HIL1 may be in contact with an upper surface of the first electrode EL1. However, the embodiment of the inventive concept is not limited thereto, and the first hole transport region HTR1 may further include a first hole-side additional layer disposed on the first hole transport layer HTL1. The first hole-side additional layer may include at least one of a hole buffer layer, an emission auxiliary layer, or an electron blocking layer. The hole buffer layer may be a layer, which increases light emission efficiency by compensating for a resonance distance according to a wavelength of light emitted from an emission layer. The electron blocking layer may be a layer, which functions to prevent electrons from being injected from an electronic transport region to a hole transport region.

The first electron transport region ETR1 may include a first electron transport layer ETL1 disposed on the first emission layer EML-R1. The first electron transport layer ETL1 may be disposed between the first emission layer EML-R1 and the charge generation layer CGL and may contact the first emission layer EML-R1. The first electron transport region ETR1 may further include a first electron injection layer EIL1 disposed between the first electron transport layer ETL1 and the charge generation layer CGL. The first electron injection layer EIL1 may be in contact with the charge generation layer CGL. The first electron transport region ETR1 may further include a first electron-side additional layer disposed between the first electron transport layer ETL1 and the first emission layer EML-R1. The first electron-side additional layer may include at least one of an electron buffer layer or a hole blocking layer.

The second light emitting stack ST2 may further include the second hole transport region HTR2 for transporting holes generated from the charge generation layer CGL to the second emission layer EML-R2 and a second electron transport region ETR2 for transporting electrons provided from the second electrode EL2 to the second emission layer EML-R2.

The second hole transport region HTR2 may include a second hole injection layer HIL2 disposed on the charge generation layer CGL and a second hole transport layer HTL2 disposed on the second hole injection layer HIL2. The second hole transport layer HTL2 may be in contact with a lower surface of the second emission layer EML-R2. The second hole injection layer HIL2 may be in contact with an upper surface of the charge generation layer CGL. The second hole transport region HTR2 may further include a second hole-side additional layer disposed on the second hole transport layer HTL2. The second hole-side additional layer may include at least one of a hole buffer layer, an emission auxiliary layer, or an electron blocking layer.

The second electron transport region ETR2 may include a second electron transport layer ETL2 disposed on the second emission layer EML-R2. The second electron transport layer ETL2 may be disposed between the second emission layer EML-R2 and the second electrode EL2 and may contact the second emission layer EML-R2. The second electron transport region ETR2 may further include a second electron injection layer EIL2 disposed between the second electron transport layer ETL2 and the second electrode EL2. The second electron injection layer EIL2 may contact the second electrode EL2. The second electron transport region ETR2 may further include a second electron-side additional layer disposed between the second electron transport layer ETL2 and the second emission layer EML-R2. The second electron-side additional layer may include at least one of an electron buffer layer or a hole blocking layer.

At least one of the functional layers included in the light emitting element ED according to an embodiment includes a portion in which a dopant is included in a base material. In the light emitting element ED according to an embodiment, at least one of the first hole injection layer HIL1 and the second hole injection layer HIL2 may be a layer including a portion in which a p-type dopant is doped with a hole injection material as a base material. For example, the first hole injection layer HIL1 may be a layer including a portion in which a hole injection material is doped with a p-type dopant. In an embodiment, in the light emitting element ED according to an embodiment, the first hole injection layer HIL1 may be a layer including a portion in which a base material is doped with a p-type dopant.

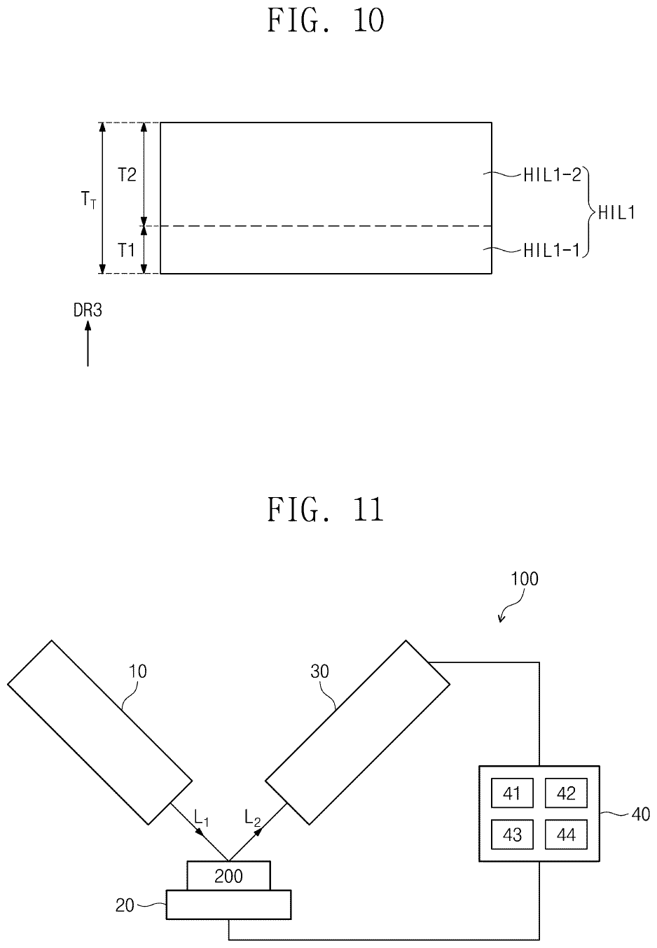

FIG. 10 is a cross-sectional view of a portion of a light emitting element according to an embodiment of the inventive concept. In FIG. 10 illustrates an enlarged layer structure of a first hole injection layer HIL1 included in the light emitting element ED of FIG. 9.

Referring to FIGS. 9 and 10 together, the first hole injection layer HIL1 may include a first layer HIL1-1 and a second layer HIL1-2. The first layer HIL1-1 may be disposed on the first electrode EL1, and the second layer HIL1-2 may be disposed on the first layer HIL1-1. The first layer HIL1-1 may be directly disposed on the first electrode EL1.

The first layer HIL1-1 may include two different materials. The first layer HIL1-1 may include a first material and a second material. The first layer HIL1-1 may include a p-type dopant as the first material. The first layer HIL1-1 may include a hole injection material as the second material.

The first layer HIL1-1 and the second layer HIL1-2 may form a single body. The first layer HIL1-1 and the second layer HIL1-2 are not separate layers in which an interface is defined therebetween, but are layers distinguished by material content, and a separate interface may not be provided between the first layer HIL1-1 and the second layer HIL1-2. The first layer HIL1-1 and the second layer HIL1-2 may be two layers, within a single layer formed of the second material, which are differentiated by material content as a portion adjacent to the first electrode EL1 is partially doped with the first material.

The p-type dopant as the first material may include at least one of a halogenated metal compound, a quinone derivative, a metal oxide, or a cyano group-containing compound. For example, the p-type dopant may include halogenated metal compounds such as CuI and RbI, quinone derivatives such as tetracyanoquinodimethane (TCNQ) and 2,3,5,6-tetrafluoro-7,7′,8,8-tetracyanoquinodimethane (F4-TCNQ), metal oxides such as tungsten oxides and molybdenum oxides, cyano group-containing compounds such as dipyrazino[2,3-f:2′,3′-h]quinoxaline-2,3,6,7,10,11-hexacarbonitrile (HATCN) and 4-[2,3-bis[cyano-(4-cyano-2,3,5,6-tetrafluorophenyl)methylidene] cyclopropylidene]-cyanomethyl]-2,3,5,6-tetrafluorobenzonitrile (NDP9), and the like. The first layer HIL1-1 may include NDP9 as the first material.

The hole injection material as the second material may include an amine compound. The hole injection material may include a triarylamine compound. For example, the hole injection material may include any one of compounds from Compound Group H below.

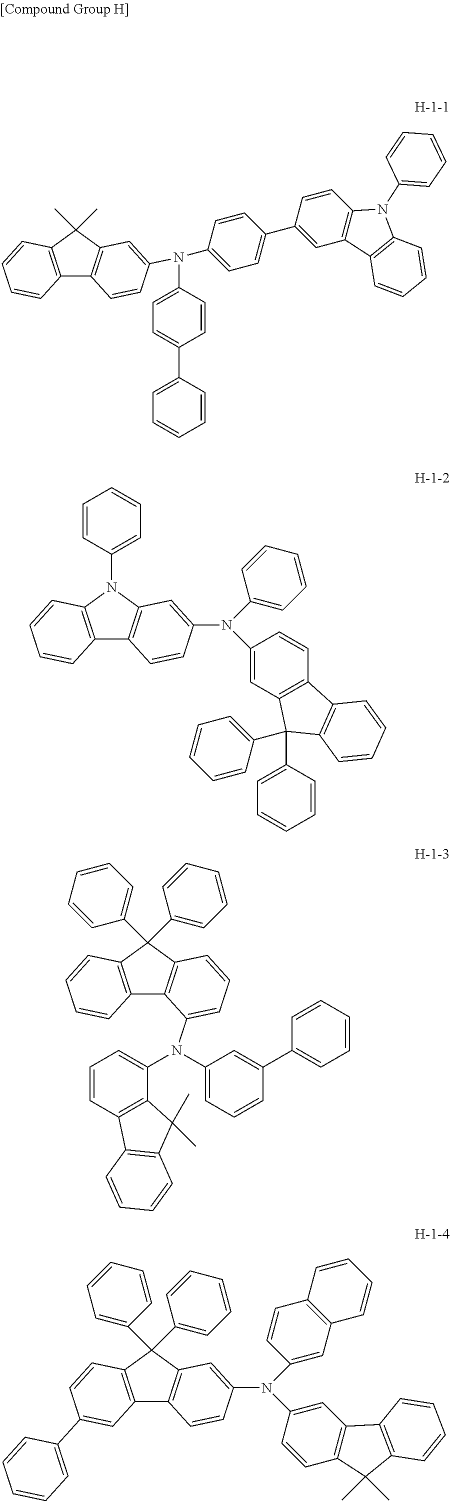 [SMILES: CC1(C)c2ccccc2-c2ccc(N(c3ccc(-c4ccccc4)cc3)c3ccc(-c4ccc5c(c4)c4ccccc4n5-c4ccccc4)cc3)cc21 ; c1ccc(N(c2ccc3c(c2)C(c2ccccc2)(c2ccccc2)c2ccccc2-3)c2ccc3c4ccccc4n(-c4ccccc4)c3c2)cc1 ; CC1(C)c2ccccc2-c2cccc(N(c3cccc(-c4ccccc4)c3)c3cccc4c3-c3ccccc3C4(c3ccccc3)c3ccccc3)c21 ; CC1(C)c2ccccc2-c2cc(N(c3ccc4c(c3)C(c3ccccc3)(c3ccccc3)c3ccc(-c5ccccc5)cc3-4)c3ccc4ccccc4c3)ccc21]

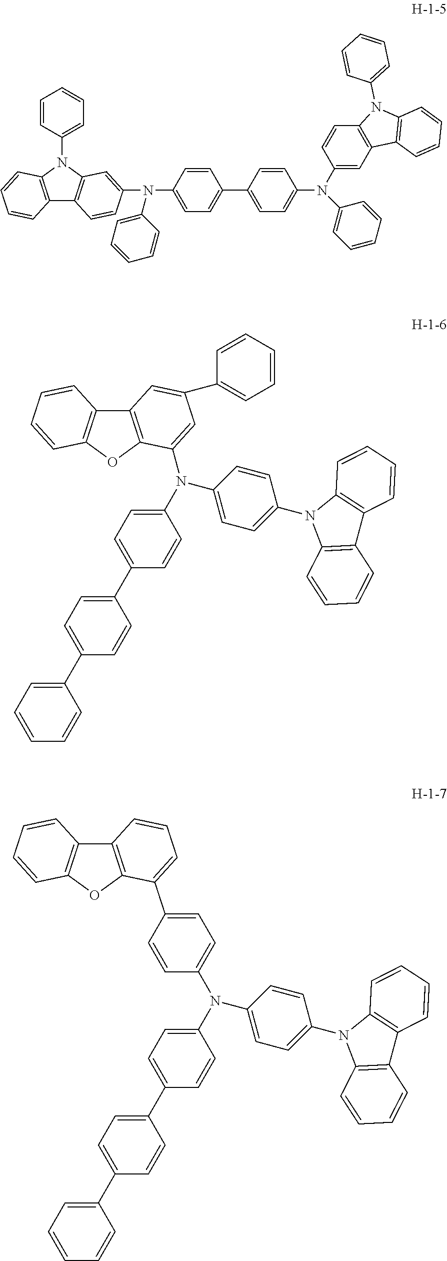 [SMILES: c1ccc(N(c2ccc(-c3ccc(N(c4ccccc4)c4ccc5c6ccccc6n(-c6ccccc6)c5c4)cc3)cc2)c2ccc3c(c2)c2ccccc2n3-c2ccccc2)cc1 ; c1ccc(-c2ccc(-c3ccc(N(c4ccc(-n5c6ccccc6c6ccccc65)cc4)c4cc(-c5ccccc5)cc5c4oc4ccccc45)cc3)cc2)cc1 ; c1ccc(-c2ccc(-c3ccc(N(c4ccc(-c5cccc6c5oc5ccccc56)cc4)c4ccc(-n5c6ccccc6c6ccccc65)cc4)cc3)cc2)cc1]

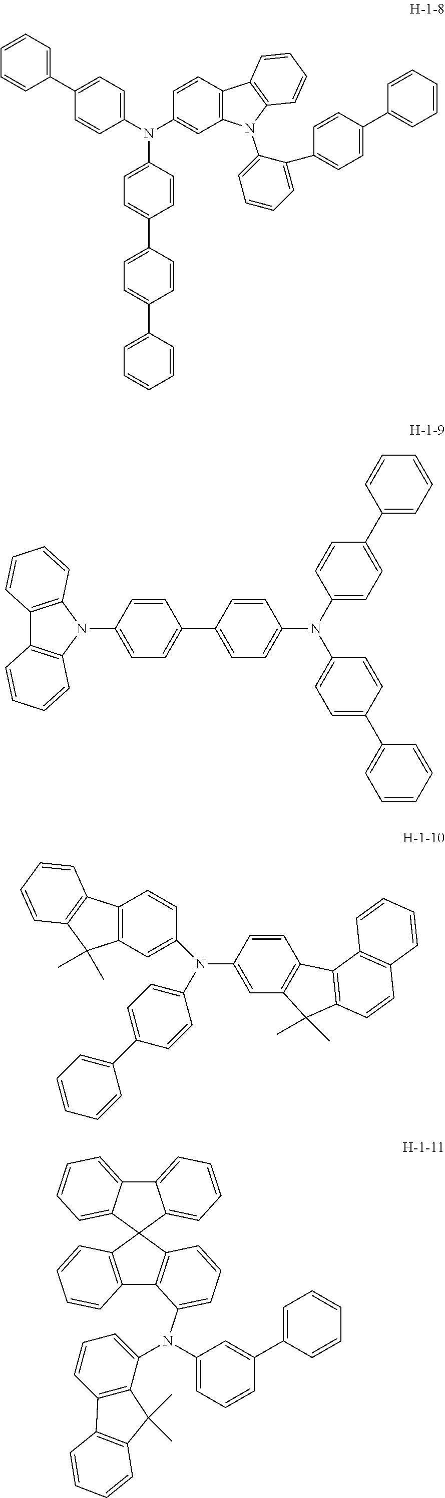

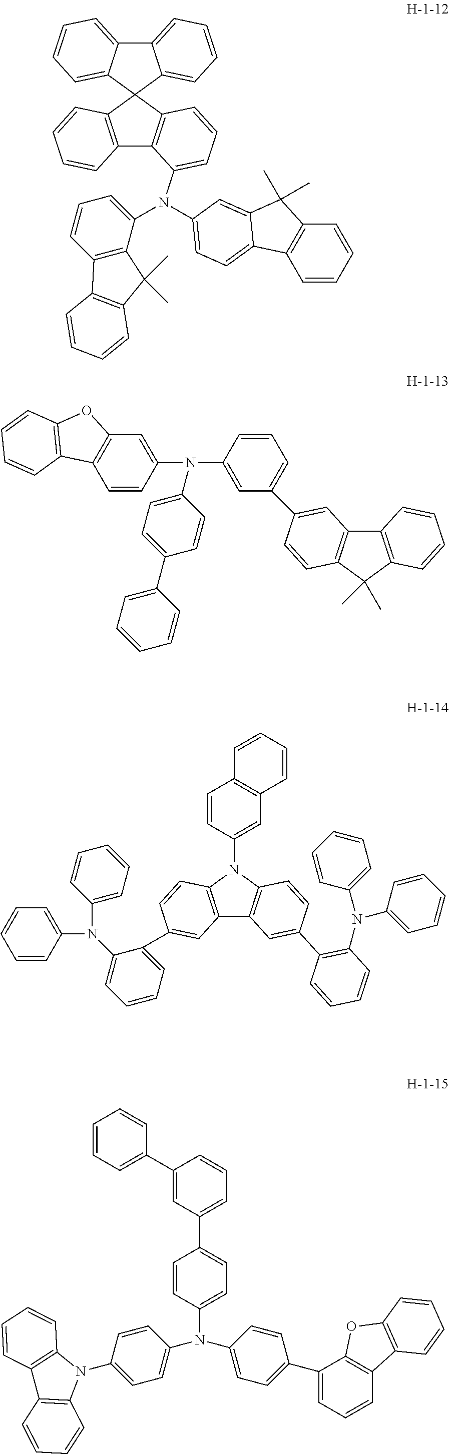 [SMILES: CC1(C)c2ccccc2-c2ccc(N(c3cccc4c3-c3ccccc3C43c4ccccc4-c4ccccc43)c3cccc4c3C(C)(C)c3ccccc3-4)cc21 ; CC1(C)c2ccccc2-c2cc(-c3cccc(N(c4ccc(-c5ccccc5)cc4)c4ccc5c(c4)oc4ccccc45)c3)ccc21 ; c1ccc(N(c2ccccc2)c2ccccc2-c2ccc3c(c2)c2cc(-c4ccccc4N(c4ccccc4)c4ccccc4)ccc2n3-c2ccc3ccccc3c2)cc1 ; c1ccc(-c2cccc(-c3ccc(N(c4ccc(-c5cccc6c5oc5ccccc56)cc4)c4ccc(-n5c6ccccc6c6ccccc65)cc4)cc3)c2)cc1]

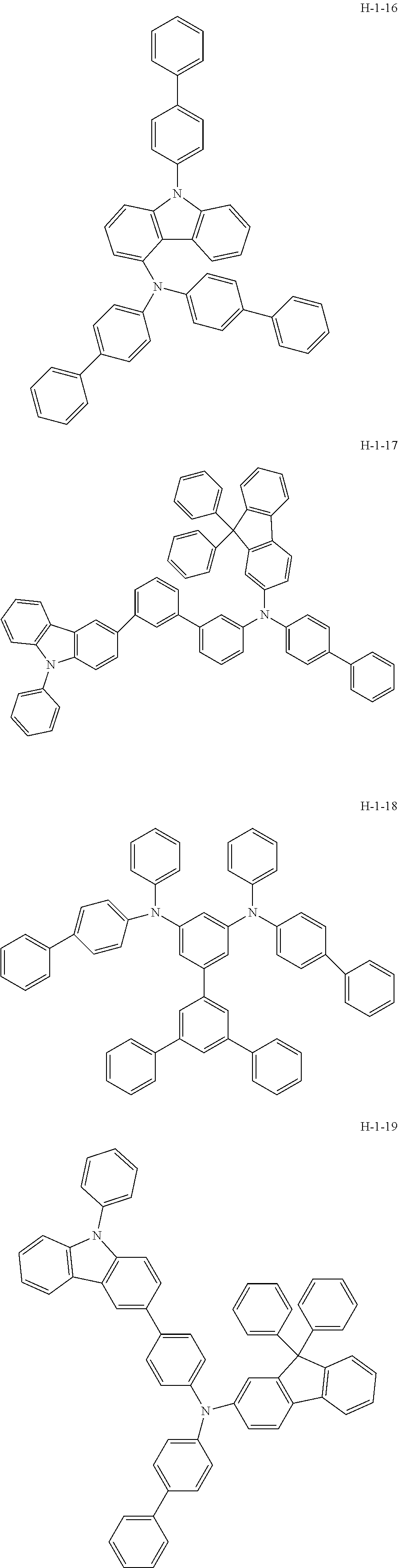 [SMILES: c1ccc(-c2ccc(N(c3ccc(-c4ccccc4)cc3)c3cccc4c3c3ccccc3n4-c3ccc(-c4ccccc4)cc3)cc2)cc1 ; c1ccc(-c2ccc(N(c3cccc(-c4cccc(-c5ccc6c(c5)c5ccccc5n6-c5ccccc5)c4)c3)c3ccc4c(c3)C(c3ccccc3)(c3ccccc3)c3ccccc3-4)cc2)cc1 ; c1ccc(-c2ccc(N(c3ccccc3)c3cc(-c4cc(-c5ccccc5)cc(-c5ccccc5)c4)cc(N(c4ccccc4)c4ccc(-c5ccccc5)cc4)c3)cc2)cc1 ; c1ccc(-c2ccc(N(c3ccc(-c4ccc5c(c4)c4ccccc4n5-c4ccccc4)cc3)c3ccc4c(c3)C(c3ccccc3)(c3ccccc3)c3ccccc3-4)cc2)cc1]

In an embodiment, the hole injection material may include a phthalocyanine compound such as copper phthalocyanine, N¹,N^{1′}-([1,1′-biphenyl]-4,4′-diyl)bis(N¹-phenyl-N⁴,N⁴-di-m-tolylbenzene-1,4-diamine) (DNTPD), 4,4′,4″-[tris(3-methylphenyl)phenylamino] triphenylamine (m-MTDATA), 4,4′4″-tris(N,N-diphenylamino)triphenylamine (TDATA), 4,4′,4″-tris[N (2-naphthyl)-N-phenylamino]-triphenylamine (2-TNATA), poly(3,4-ethylenedioxythiophene)/poly(4-styrenesulfonate) (PEDOT/PSS), polyaniline/dodecylbenzenesulfonic acid (PANI/DBSA), polyaniline/camphor sulfonicacid (PANI/CSA), polyaniline/poly(4-styrenesulfonate) (PANI/PSS), N,N′-di(naphthalene-1-yl)-N,N′-diphenyl-benzidine (NPB), triphenylamine-containing polyetherketone (TPAPEK), 4-isopropyl-4′-methyldiphenyliodonium tetrakis(pentafluorophenyl) borate, dipyrazino [2,3-f: 2′,3′-h]quinoxaline-2,3,6,7,10,11-hexacarbonitrile (HATCN), and the like.

The hole injection material may include carbazole-based derivatives such as N-phenyl carbazole and polyvinyl carbazole, fluorene-based derivatives, N,N′-bis(3-methylphenyl)-N,N′-diphenyl-[1,1-biphenyl]-4,4′-diamine (TPD), triphenylamine-based derivatives such as 4,4′,4″-tris(N-carbazolyl)triphenylamine (TCTA), N,N′-di(1-naphtalene-1-yl)-N,N′-diphenyl-benzidine (NPB), 4,4′ cyclohexylidene bis[N,N-bis(4-methylphenyl]benzenamine] (TAPC), 4,4′-bis[N,N′-(3-tolyl)amino]-3,3′-dimethylbiphenyl (HMTPD), 1,3-bis(N-carbazolyl)benzene (mCP), and the like.

In addition, the hole injection material may include 9-(4-tert-butylphenyl)-3,6-bis(triphenylsilyl)-9H-carbazole (CzSi), 9-phenyl-9H-3,9′-bicarbazole (CCP), 1,3-bis(1,8-dimethyl-9H-carbazol-9-yl)benzene (mDCP), and the like.

In the first layer HIL1-1, the first material may be included in a smaller amount than the second material. The first material, which is a p-type dopant, may be a substance resulting from doping the first layer HIL1-1, formed from a base material, with a small amount of hole injecting material. With respect to total materials of the first layer HIL1-1, the content of the first material may be greater than about 0 wt % and about 1.5 wt % or less. The first layer HIL1-1 may be formed of the first material and the second material. The first material, which is a p-type dopant, may be uniformly or non-uniformly dispersed in the first layer HIL1-1.

The second layer HIL1-2 may be a layer that is not doped with the first material, which is a p-type dopant. The second layer HIL1-2 may be a layer having a lower content of the first material compared to the first layer HIL1-1. In an embodiment, the second layer HIL1-2 may be a layer formed of a hole injection material, which is the second material. In an embodiment, the second layer HIL1-2 may be a layer that includes a trace amount of the first material and is mostly formed of the second material. With respect to total materials of the second layer HIL1-2, the content of the first material may range from about 0 wt % to about 0.5 wt %. The trace amount of the first material included in the second layer HIL1-2 may result from some of the p-type dopant dispersing at a position of the second layer HIL1-2 during the process of doping the hole injection material with the p-type dopant to form the first layer HIL1-1.

In the first hole injection layer HIL1, the first layer HIL1-1 may have a smaller thickness than the second layer HIL1-2. In an embodiment, the first hole injection layer HIL1 may have a thickness TT of about 300 Å to about 400 Å. The first layer HIL1-1 may have a first thickness Tl of about 80 Å to about 120 Å. The second layer HIL1-2 may have a thickness of about 220 Å to about 280 Å.

FIG. 10 illustrates that the first layer HIL1-1 is adjacent to the first electrode EL1, but the embodiment of the inventive concept is not limited thereto, and the first layer HIL1-1 may be positioned in the middle of the first hole injection layer HIL1, or may be positioned on an upper portion of the first hole injection layer HIL1. The first layer HIL1-1 is a layer formed through the doping of a p-type dopant, and the position of the first layer HIL1-1 within the first hole injection layer HIL1 may vary depending on the doping position of the p-type dopant in the process of forming the first hole injection layer HIL1.

The first hole injection layer HIL1 may correspond to a functional layer that is an inspection target inspected through an inspection device and an inspection method according to an embodiment, which will be described later. That is, the inspection target inspected through the inspection device and the inspection method according to an embodiment may include the same layer structure as the first hole injection layer HIL1 described in FIGS. 9 and 10, and may be formed of the same material.

In FIG. 10, the first hole injection layer HIL1 is illustrated as an example of a functional layer to be inspected, but the embodiment of the inventive concept is not limited thereto, and the upper charge generation layer CGL-2 illustrated in FIG. 9 may correspond to a functional layer to be inspected through the inspection device and the inspection method according to an embodiment. For example, the upper charge generation layer CGL-2 may have a structure including a first layer including a first material and a second material, and a second layer including a second material, like the first hole injection layer HIL1 illustrated in FIG. 10.

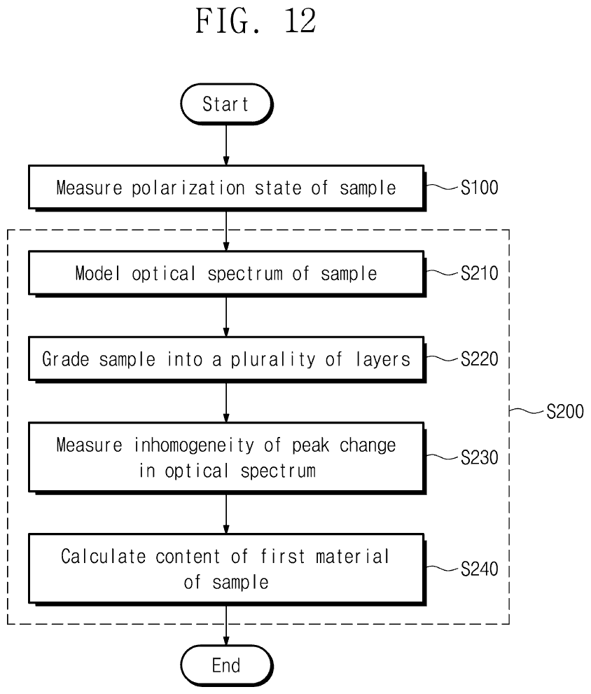

FIG. 11 is a block diagram briefly showing a functional layer inspection device 100 according to an embodiment.

Referring to FIG. 11, the functional layer inspection device 100 is a device that irradiates a sample whose properties are to be measured with light and measures changes in the intensity and phase of the light to determine various properties of the sample material, such as asymmetry, thickness, refractive index, and surface roughness, in a non-destructive manner. For example, the functional layer inspection device 100 may be a spectroscopic ellipsometer.

The functional layer inspection device 100 according to an embodiment of the inventive concept may be used to analyze property values of a sample 200 including a specific material. The functional layer inspection device 100 may include an incident part 10 that irradiates the sample 200 including a mixed material to be measured with incident light L₁, and a receiving part 30 that receives emitted light L₂ reflected, refracted, transmitted, and scattered from the sample 200. In addition, the functional layer inspection device 100 may further include a computing module 40 that calculates necessary data based on information about light collected from a base substrate 20 on which the sample 200 is placed for measurement and the receiving part 30, and controls the operation of the functional layer inspection device 100 accordingly.

The incident part 10 may include a light source that emits incident light L₁ including parallel light, a polarizer that polarizes the incident light L₁, and a first compensator that adjusts or delays the phase of the polarized incident light L₁ to emit the polarized incident light L₁.

The receiving part 30 may include a second compensator that corrects the polarization state of the emitted light L₂ that is reflected, refracted, transmitted, and scattered after the polarized incident light L₁ passes through the sample 200 at a ratio different from that of the first compensator (adjusting or delaying the phase of the emitted light L₂). The emitted light L₂ may be an elliptically polarized beam. The receiving part 30 may include a spectrometer for analyzing data such as wavelength and polarization of the emitted light L₂, and an analyzer for measuring an amount of the emitted light L₂. The spectrometer may determine orthogonal components of polarization of the emitted light L₂. The analyzer may receive the analyzed emitted light L₂, generate a charge corresponding to the amount of received emitted light L₂, and output the charge to the computing module 40. The analyzer may include a two-dimensional image sensor such as CMOS or CCD.

An ellipsometer in which two optical elements rotate at the same speed with a constant speed ratio, such as a dual-rotating-element ellipsometer, is widely used. Specifically, various types of ellipsometers may be provided by combining polarizers and analyzers, compensators and analyzers, polarizers and compensators, and the like. In an embodiment of the inventive concept, the incident part 10 and the receiving part 30 are known as components included in a dual compensator ellipsometer, but this is an example of an ellipsometer, and the components of the inventive concept are not limited thereto.

The sample 200 may be placed on the base substrate 20. The base substrate 20 may be, for example, a glass substrate. A driving device that rotates the base substrate 20 clockwise or counterclockwise may be disposed below the base substrate 20. In this case, the polarized incident light L₁ may be configured to inspect the sample 200 in any direction or within a preset rotation range. A rotation interval of the base substrate 20 may be determined according to an inspection environment. The driving device that rotates the base substrate 20 may include at least one actuator that generates continuous, stepwise, and highly variable rotation of the sample 200.

The computing module 40 may include a computing part for calculating properties such as the content and thickness of a material included in the sample 200. The computing part may analyze information such as the wavelength and light quantity of the emitted light L₂ detected through the receiving part 30. The computing module 40 may include a control portion that controls the base substrate 20 to rotate to another azimuth once measurement at a specific azimuth is complete. In this case, the azimuth refers to a relative position of a sample with respect to a reference position (azimuth of 0°) of the polarized incident light L₁. That is, the azimuth may correspond to a direction of the sample 200 with respect to the reference position.

In an embodiment, the computing module 40 includes a first computing part 41, a second computing part 42, a third computing part 43, and a fourth computing part 44. The functions of each computing part included in the computing module 40 will be described in more detail in the description of a functional layer inspection method using a functional layer inspection device, which will be described later. In FIG. 11, the first computing part 41, the second computing part 42, the third computing part 43, and the fourth computing part 44 are each illustrated as separate components, but the embodiment of the inventive concept is not limited thereto, and two or more computing parts may form a single body and may be processors that perform a plurality of functions.

The computing module 40 and/or at least one component included in the computing module 40 may be implemented through general purpose and/or special purpose components such as at least one discrete circuit, digital signal processing chips, integrated circuits, microprocessors, processors, programmable arrays, field programmable arrays, and instruction set processors. The features, functions, processes, and the like described herein may be implemented through software, hardware (general processors, digital signal processing chips, field programmable arrays, or the like), firmware, or a combination thereof. For example, the computation module 40 and/or at least one component may be associated with or include at least one memory including code (instructions) that enables the computation module 40 and/or at least one component to perform at least one feature, function, or process described herein.

The memory may be any medium that participates in providing code to at least one software, hardware, and/or firmware component for execution. The memory may be implemented in any suitable form, including non-volatile media, volatile media, and transmission media. The non-volatile media may include, for example, optical or magnetic disks. The volatile media include dynamic memory devices. The transmission media may include coaxial cables, copper wires, and optical fibers. Communication media may also take the form of ultrasonic, optical, or electromagnetic waves. Common computer-readable media may include, for example, a floppy disk, a flexible disk, a hard disk, a magnetic tape, other magnetic media, a compact disk-read only memory (CD-ROM), a rewriteable compact disk (CDRW), a digital video disk (DVD), a rewriteable DVD-RW (DVD-RW), other optical media, a punch card, a paper tape, an optical mark sheet, other physical media having a pattern of holes or optically recognizable marks, a random-access memory (RAM), a programmable read only memory (PROM), an erasable programmable read only memory (EPROM), a FLASH-EPROM, other memory chips or cartridges, a carrier wave, or other media from which information may be read.

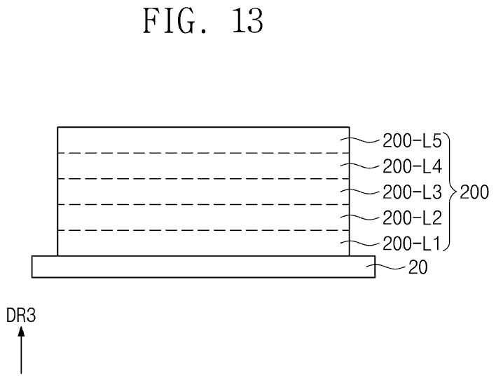

FIG. 12 is a flowchart of a functional layer inspection method according to an embodiment.

Referring to FIG. 12, the functional layer inspection method according to an embodiment includes a first step (S100) of measuring a polarization state of a sample on a base substrate through an inspection device, and a second step (S200) of calculating a physical property value of the sample through measurement data. The physical property value calculated through the functional layer inspection method may be the thickness of the sample, content of each material included in the sample, etc. The second step (S200) includes modeling an optical spectrum of the sample (S210), grading the sample into a plurality of layers in a thickness direction of the sample (S220), measuring inhomogeneity of peak changes in the optical spectrum of each layer of the sample divided into the plurality of layers (S230), and calculating an analysis value to calculate content of the first material of the sample (S240).

Referring to FIGS. 11 and 12 together, in the first step (S100), a sample 200 on a base substrate 20 is irradiated with incident light L₁ by a polarized incident part 10, and after the polarized incident light L₁ passes through the sample 200, the polarization state of emitted light L₂ reflected, refracted, transmitted, and scattered is collected by a receiving part 30. The incident part 10 may include a light source that emits incident light L₁ including parallel light, a polarizer that polarizes the incident light L₁, and a first compensator that adjusts or delays the phase of the polarized incident light L₁ to emit the polarized incident light L₁. The receiving part 30 may include a second compensator that corrects the polarization state of the emitted light L₂ that is reflected, refracted, transmitted, and scattered after the polarized incident light L₁ passes through the sample 200 at a ratio different from that of the first compensator. The receiving part 30 may include a spectrometer for analyzing data such as wavelength and polarization of the emitted light L₂, and an analyzer for measuring an amount of the emitted light L₂.

The sample 200 includes a first material and a second material. The sample 200 is a functional layer such as the first hole injection layer HIL1 (FIG. 10) described above, and may include a hole injection material as the first material and a p-type dopant as the second material. The sample 200 may have a form in which a hole injection material is used as a base material and a portion of the base material is doped with a p-type dopant.

In the second step (S200), the modeling of an optical spectrum of the sample (S210) is performed by the first computing part 41 included in a computing module 40.

In the modeling (S210), the optical spectrum of the sample 200 is modeled using effective medium approximation (EMA). FIG. 12 illustrates that the modeling (S210) is performed after the first step (S100) and the grading (S220) is performed after the modeling (S210), but this does not mean a time series order. The modeling (S210) may involve modeling the optical spectrum by the sample 200 using effective medium approximation regardless of the polarization state value measured in the first step (S100). The effective medium approximation is a method of applying a change in refractive index caused by internal stress or process change when there is a standard refractive index in thin film analysis, and is a formula primarily used to calculate an effective refractive index of a mixture when two or more materials each having different dielectric constants and irregular distributions smaller than wavelength are present in the same thin film. In an embodiment, the sample 200 is a functional layer such as the first hole injection layer HIL1 (FIG. 10) described above, and has a form in which a hole injection material as a base material is partially doped with a p-type dopant, and accordingly, in the functional layer inspection method according to an embodiment, physical properties of the sample 200, such as refractive index, may be modeled through effective medium approximation.

In the second step (S200), the grading (S220) is performed to divide the sample 200 into a plurality of layers in the thickness direction of the sample 200 by the second computing part 42 included in the computing module 40.

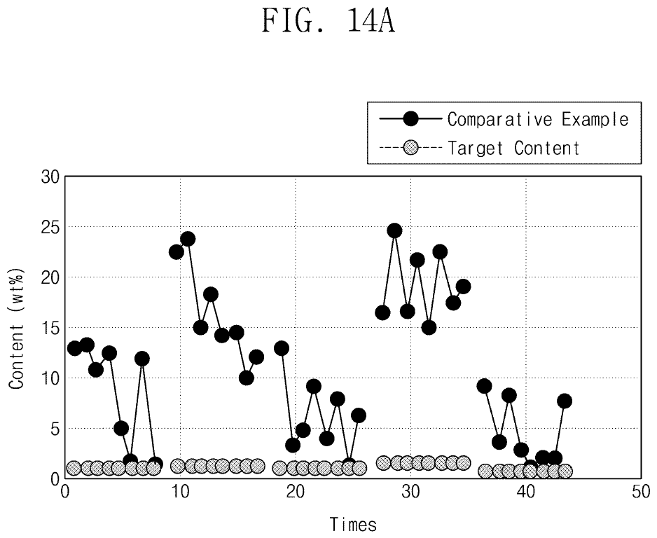

FIG. 13 is a cross-sectional view of a sample inspected through a functional layer inspection method according to an embodiment. FIG. 13 briefly illustrates a cross-section for describing the graded shape of the sample in the thickness direction in the grading of the second step from the functional layer inspection method.

Referring to FIGS. 11 to 13 together, the sample 200 is divided into a plurality of layers in the third direction DR3, which is the thickness direction, by the second computing part 42 included in the computing module 40. FIG. 13 illustrates, as an example, the sample 200 divided into five layers in the third direction DR3, but the embodiment of the inventive concept is not limited thereto, and the sample 200 may be divided into four or fewer layers or six or more layers in the grading. For example, the sample 200 may be divided into three to five layers in the grading. The divided plurality of layers may not be separate layers physically separated by an interface, but may be arbitrary sub-layers compartmentalized by a virtual dividing line in the thickness direction. The divided plurality of layers may be connected to each other to form a single body.

In the grading, the sample 200 is separated into a plurality of layers, and each of the divided plurality of layers may have substantially the same thickness. Herein, “substantially the same” in thickness includes a case in which numerical values are physically identical, and also a case in which errors occur in processes and modeling despite the same design. In an embodiment, the sample 200 may be divided into a total of five layers, a first sub-layer 200-L1, a second sub-layer 200-L2, a third sub-layer 200-L3, a fourth sub-layer 200-L4, and a fifth sub-layer 200-L5, and thicknesses of each sub-layer may be substantially the same.

The second step (S200) may further include calculating a total thickness of the sample 200 prior to the grading (S220). Prior to the grading (S220), the total thickness of the sample 200 may be calculated using the polarization state value measured in the first step (S100). In an embodiment, the total thickness of the sample 200 may be calculated using the optical spectrum modeled using effective medium approximation. The sample 200 may have a thickness of about 300 Å to about 400 Å.

In the second step (S200), the measuring of inhomogeneity of peak changes in the optical spectrum of each of the plurality of layers (S230) is performed by the third computing part 43 included in the computing module 40.

The inhomogeneity refers to a degree to which materials are not uniformly mixed with respect to a thin film in which two or more materials are mixed. In an embodiment, the sample 200 corresponds to a functional layer in which a hole injection material as a base material is partially doped with a p-type dopant, i.e., the first hole injection layer HIL1 (FIG. 10), and a case in which inhomogeneity is high corresponds to a case in which the p-type dopant is not uniformly mixed in the sample 200 and the p-type dopant content in some parts differs significantly from the p-type dopant content in other parts.

In the measuring of inhomogeneity (S230), inhomogeneity is measured for each layer of the sample 200 divided into the plurality of layers in the previous step of grading. For the sample 200 illustrated in FIG. 13, the inhomogeneity of the p-type dopant may be measured for each of the first sub-layer 200-L1, the second sub-layer 200-L2, the third sub-layer 200-L3, the fourth sub-layer 200-L4, and the fifth sub-layer 200-L5. In the measuring of the inhomogeneity (S230), the inhomogeneity of each layer may be measured by analyzing changes in the fine peak of the optical spectrum for each layer of the sample 200.

In the second step (S200), the calculating of an analysis value by the fourth computing part 44 included in the computing module 40 to calculate content of the first material of the sample (S240) is performed. In the calculating of content of the first material of the sample 200 (S240), the content of the first material of the sample 200 may be calculated by considering the optical spectrum modeled using effective medium approximation in the previous step of modeling (S210) and the inhomogeneity of each of the plurality of layers measured in the grading (S220) and the measuring of inhomogeneity (S230) together.

In the functional layer inspection method according to an embodiment, for a sample including a plurality of materials and having a plurality of layers distinguished by material content, a physical property value is calculated through an optical spectrum modeled using effective medium approximation, and after arbitrarily dividing and grading the plurality of layers, inhomogeneity is measured and taken into account together, and thus, measuring precise content even for the content of a material included in a trace amount is achievable.

Unlike the functional layer inspection method according to an embodiment, when a physical property value is calculated through only the optical spectrum modeled using effective medium approximation for a sample including a plurality of materials, the content of a material may not be measured accurately. In particular, when a material is included in a trace amount and the first hole injection layer HIL1, as described in FIG. 10, is locally doped with a specific material (p-type dopant), a spectrum of the specific material included in a trace amount is weak and a correlation phenomenon occurs between a layer including the specific material and a layer not including the specific material, which may lead to the content of the specific material not being accurately measured and exhibiting significant scatter.

In an embodiment of the functional layer inspection method, the physical property value is calculated through the optical spectrum modeled using effective medium approximation, and the sample is divided into arbitrary layers and graded, and then inhomogeneity is measured. Thereafter, the thickness of the sample and the content of each material are calculated by considering the optical spectrum modeled using the effective medium approximation and the inhomogeneity of each layer together, and accordingly, even when the sample includes a specific material such as a p-type dopant in a trace amount and is locally doped with the material, content of the material included in the sample may be precisely calculated. Therefore, the sample inspected through the functional layer inspection method according to an embodiment and a functional layer inspection device used therefor may have improved consistency.

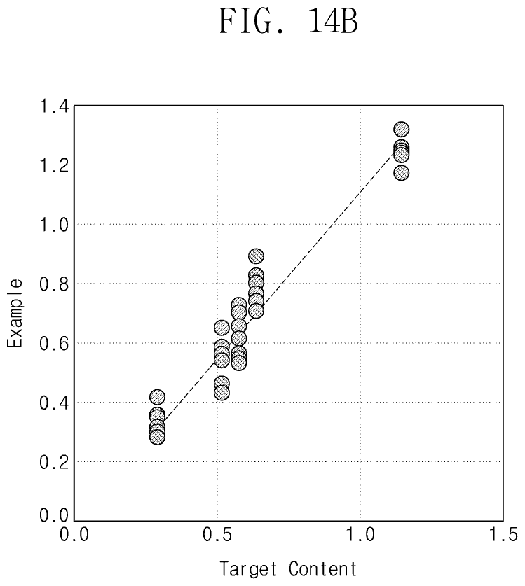

FIG. 14A is a graph showing a content measurement value of a target material according to a functional layer inspection method of a Comparative Example. FIG. 14B is a graph showing a content measurement value of a target material according to a functional layer inspection method of an Example.

In FIG. 14A is a graph of Comparative Example measuring content of a p-type dopant of a sample only through an optical spectrum modeled using effective medium approximation and comparing the content with target content. Referring to FIG. 14A, the target content of the p-type dopant of the sample is a trace amount of 0.57 wt %, but a measured content value is found to be up to 25 wt %, and it is observed that there is significant scatter among the measured values. In the inspection method of Comparative Example, the content of the p-type dopant, which is a material to be measured, in the sample is very low, and the sample is locally doped with the p-type dopant which is not uniformly distributed, resulting in significant scatter among the measured values.

In FIG. 14B, in the inspection method of the Example, content of the p-type dopant of the sample was calculated through the optical spectrum modeled using effective medium approximation, and the sample was divided into three arbitrary layers and graded, and then inhomogeneity was measured, and the content of the p-type dopant of the sample was calculated by considering the optical spectrum modeled using effective medium approximation and the inhomogeneity of each layer together. Thereafter, target content values were plotted on the x-axis, and calculated content values were plotted on the y-axis for comparison.

Referring to the graph of the Example, unlike the Comparative Example, the scatter between the target content and the calculated content is not significant, and when a trend line is drawn with respect to the measured values, an R² value is observed at about 95%. Accordingly, it is determined that in the Example, by considering the optical spectrum modeled using effective medium approximation and the inhomogeneity of each layer together, precise content measurement is achievable even for materials present in a trace amount and locally and non-uniformly included.

In a functional layer inspection method and inspection device according to an embodiment, even when a sample includes a trace amount of a specific material, such as a p-type dopant, and is locally doped with the specific material, content of the material included in the sample may be precisely calculated, and accordingly, the sample inspected through the functional layer inspection method and the functional layer inspection device used therefor may have improved consistency.

In the above, description has been made with reference to embodiments of the inventive concept, but those skilled or of ordinary skill in the art may understand that various modifications and changes may be made to the inventive concept insofar as such modifications and changes do not depart from the spirit and technical scope of the inventive concept set forth in the claims to be described later.

Therefore, the technical scope of the inventive concept is not to be limited to the contents stated in the detailed description of the specification, but should be determined by the claims.

What is claimed is:

1. A functional layer inspection method comprising:
measuring a polarization state of a sample on a base substrate through an inspection device; and
calculating a physical property value of the sample through measurement data,
wherein the sample includes a first material and a second material,
the calculating includes:
modeling an optical spectrum of the sample;
grading the sample into a plurality of layers in a thickness direction of the sample;
measuring inhomogeneity of peak changes in the optical spectrum of each of the plurality of layers; and
calculating an analysis value to calculate content of the first material of the sample.

2. The functional layer inspection method of claim 1, wherein in the modeling, the optical spectrum of the sample is modeled using effective medium approximation.

3. The functional layer inspection method of claim 1, wherein in the grading, the sample is divided into 3 to 5 layers in the thickness direction.

4. The functional layer inspection method of claim 1, wherein the first material is a p-type dopant, and the second material is a base material in which the p-type dopant is dispersed.

5. The functional layer inspection method of claim 1, wherein the sample comprises:
a first layer in which the first material and the second material are mixed; and
a second layer disposed on the first layer and having a content of the first material lower than a content of the first material in the first layer.

6. The functional layer inspection method of claim 5, wherein in the first layer, the content of the first material is 1.5 wt % or less with respect to total materials of the first layer.

7. The functional layer inspection method of claim 5, wherein the first layer has a thickness smaller than a thickness of the second layer.

8. The functional layer inspection method of claim 5, wherein:
the first layer has a thickness of 80 Å to 120 Å; and
the second layer has a thickness of 220 Å to 280 Å.

9. The functional layer inspection method of claim 1, wherein the sample has a total thickness of 300 Å to 400 Å.

10. The functional layer inspection method of claim 1, wherein the calculating the physical property value of the sample further comprises calculating a total thickness of the sample prior to the grading.

11. The functional layer inspection method of claim 1, wherein in the grading, the plurality of layers forms a single body.

12. The functional layer inspection method of claim 1, wherein the base substrate is a glass substrate.

13. The functional layer inspection method of claim 1, wherein the inspection device comprises:
an incident part configured to provide light to the sample;
a receiving part configured to collect light reflected from the sample; and
a computing module configured to detect, correct, and compute the light collected from the receiving part.

14. The functional layer inspection method of claim 1, wherein in the grading, each of the plurality of layers has a same thickness.

15. A functional layer inspection device comprising:
an incident part configured to provide light to a sample;
a receiving part configured to collect light reflected from the sample; and
a computing module configured to detect, correct, and compute the light collected from the receiving part,
wherein the sample includes a first material and a second material,
the computing module includes:
a first computing part configured to model an optical spectrum of the sample;
a second computing part configured to grade the sample into a plurality of layers in a thickness direction of the sample;
a third computing part configured to measure inhomogeneity of peak changes in the optical spectrum of each of the plurality of layers; and
a fourth computing part configured to calculate an analysis value to calculate content of the first material of the sample.

16. The functional layer inspection device of claim 15, wherein the first computing part models the optical spectrum of the sample using effective medium approximation.

17. The functional layer inspection device of claim 15, wherein the second computing part divides the sample into 3 to 5 layers in the thickness direction.

18. The functional layer inspection device of claim 15, wherein each of the plurality of layers has a same thickness.

19. The functional layer inspection device of claim 15, wherein the first material is a p-type dopant, and the second material is a base material in which the p-type dopant is dispersed.

20. The functional layer inspection device of claim 15, wherein the sample comprises:
a first layer in which the first material and the second material are mixed; and
a second layer disposed on the first layer and formed of the second material.
